(19) United States
(12) Patent Application Publication
(10) Pub. No.: US 2025/0207462 A1
(43) Pub. Date: Jun. 26, 2025

(54) INVERTED Y-SHAPED FOLDABLE LADDER HAVING A PIVOTAL LINKAGE

(71) Applicant: Luhao Leng, Xiamen City (CN)

(72) Inventor: Luhao Leng, Xiamen City (CN)

(21) Appl. No.: 18/966,283

(22) Filed: Dec. 3, 2024

(30) Foreign Application Priority Data
Dec. 20, 2023 (CN) 202323475703.3

(51) Int. Cl. E06C 1/20; E06C 1/387; E06C 7/18

(52) U.S. Cl. CPC E06C 1/20; E06C 1/387; E06C 7/182

(57) ABSTRACT

An inverted Y-shaped foldable ladder having a pivotal linkage includes two ladder frames symmetrically arranged, a plurality of stepping platforms, one or more pulling rods, and one or more rear leg connecting rods. Each of the two ladder frames includes a front leg tube and a rear leg tube, and the front leg tube and the rear leg tube form an inverted Y-shaped unfolding and folding structure. The plurality of stepping platforms are disposed between the front leg tubes of the two ladder frames. The one or more pulling rods are connected to one or more sides of each of the plurality of stepping platforms, and two ends of each of the one or more rear leg connecting rods are respectively pivotally connected to a corresponding one of the rear leg tubes of the two ladder frames and one of the plurality of stepping platforms.

### RELATED APPLICATIONS

This application claims priority to Chinese patent application number 202323475703.3, filed on Dec. 20, 2023. Chinese patent application number 202323475703.3 is incorporated herein by reference.

### FIELD OF THE DISCLOSURE

The present disclosure relates to the technical field of folding ladders and in particular to an inverted Y-shaped foldable ladder having a pivotal linkage.

### BACKGROUND OF THE DISCLOSURE

In daily work and life, people often use stools or ladders to conveniently access items placed at heights or to install, unload, and maintain electrical equipment situated high up. Stools can be unstable when stepped on, posing significant safety risks. Non-foldable ladders are bulky and inconvenient for storage and movement. The stepping platforms of foldable ladders typically are directly pivotally connected to the front leg pipes and the rear leg pipes, which makes the stepping platforms inflexible when folding and prone to getting stuck when unfolded or partially folded.

In existing technology, such as in patent CN208184638U, the applicant adds pulling rods connected to the stepping platforms. The pulling rods are connected to the rear leg pipes via rear leg pipe connecting rods. This structure allows the stepping platforms to fold more flexibly as the front leg pipes and the rear leg pipes rotate relative to each other to enable the pulling rods to drive the stepping platforms to fold. However, since the pulling rods are connected to the rear leg pipes, when the rear leg pipes are under stress, the rear leg pipes exert force on the pulling rods through the rear leg pipe connecting rods. Over time, this can lead to deformation of the pulling rods, affecting the durability and reliability of the folding ladder.

### BRIEF SUMMARY OF THE DISCLOSURE

The technical problem to be solved by the present disclosure is to provide an inverted Y-shaped foldable ladder having a pivotal linkage.

In order to solve the above technical problems, a technical solution is described as below.

An inverted Y-shaped foldable ladder having a pivotal linkage comprises two ladder frames symmetrically arranged, a plurality of stepping platforms, one or more pulling rods, and one or more rear leg connecting rods. Each of the two ladder frames comprises a front leg tube and a rear leg tube, and the front leg tube and the rear leg tube form an inverted Y-shaped unfolding and folding structure. The plurality of stepping platforms are disposed between the front leg tubes of the two ladder frames. The one or more pulling rods are connected to one or more sides of each of the plurality of stepping platforms, and two ends of each of the one or more rear leg connecting rods are respectively pivotally connected to a corresponding one of the rear leg tubes of the two ladder frames and one of the plurality of stepping platforms.

In the above technical solution, the one or more pulling rods synchronously drive the plurality of stepping platforms to fold. Through cooperation between the one or more pulling rods, the plurality of stepping platforms, and the one or more rear leg connecting rods, the rear leg tubes and the plurality of stepping platforms can be folded flexibly. Additionally, since pivoting points of the one or more rear leg connecting rods are disposed on the plurality of stepping platforms and the plurality of stepping platforms are sturdier than the one or more rear leg connecting rods, an unfolding process of the rear leg tubes can be better supported. The plurality of stepping platforms are also less prone to deformation, offering greater durability and reliability.

In one possible implementation, a first of the two ends of each of the one or more rear leg connecting rods pivotally connected to the one of the plurality of stepping platforms is higher than a second of the two ends of each of the one or more rear leg connecting rods pivotally connected to the corresponding one of the rear leg tubes of the two ladder frames.

In one possible implementation, a rear section of the one of the plurality of stepping platforms connected to the one or more rear leg connecting rods extends outwardly by a first length, and the one or more rear leg connecting rods are pivotally connected to the rear section of the one of the plurality of stepping platforms. In above technical solution, the rear section of the one of the plurality of stepping platforms extends outwardly, ensuring that a width between the one or more rear leg connecting rods is greater than a width between the one or more pulling rods, and preventing the one or more rear leg connecting rods and the one or more pulling rods from overlapping when the inverted Y-shaped foldable ladder is folded.

In one possible implementation, a front section of each of the plurality of stepping platforms extends outwardly by a second length, and the front leg tubes of the two ladder frames are pivotally connected to the front section of each of the plurality of stepping platforms. The second length is greater than the first length. In above technical solution, a width between the front leg tubes of the two ladder frames is greater than a width between the one or more rear leg connecting rods, allowing the one or more pulling rods and the one or more rear leg connecting rods to be stored between the two ladder frames during folding, resulting in a more orderly and aesthetically pleasing shape.

In one possible implementation, a supporting rod is connected to the rear leg tubes of the two ladder frames, and a bottom of an uppermost one of the plurality of stepping platforms is configured to abut the supporting rod. Further preferably, the bottom of the uppermost one of the plurality of stepping platforms is disposed with a rotatable buckle. When the uppermost one of the plurality of stepping platforms is unfolded, the rotatable buckle is buckled to the supporting rod. The rotatable buckle can serve as a handle for unfolding or folding the inverted Y-shaped foldable ladder, enhancing the convenience of use. When unfolding, the rotatable buckle can be buckled to the supporting rod to improve the stability of the plurality of stepping platforms.

In one possible implementation, a length of an uppermost one of the plurality of stepping platforms is greater than or equal to a length of others of the plurality of stepping platforms. Further preferably, a top-down positive projection of an upper one of the plurality of stepping platforms partially covers a lower one of the plurality of stepping platforms. In above technical solution, since adjacent two of the plurality of stepping platforms partially overlap in a vertical direction, when a user inadvertently slips off of the upper one of the plurality of stepping platforms, the user is also able to step on the lower one of the plurality of stepping platforms, mitigating injury.

In one possible implementation, each of the one or more sides of each of the plurality of stepping platforms is disposed with a protective sleeve. The protective sleeve comprises a rounded outer surface. By applying the protective covers to a left side and a right side of each of the plurality of stepping platforms, the user is prevented from being scratched by the steps.

In the present disclosure, through cooperation between the one or more pulling rods, the plurality of stepping platforms, and the one or more rear leg connecting rods, the rear leg tubes and the plurality of stepping platforms can be folded flexibly. Additionally, since pivoting points of the one or more rear leg connecting rods are disposed on the plurality of stepping platforms and the plurality of stepping platforms are sturdier than the one or more rear leg connecting rods, an unfolding process of the rear leg tubes can be better supported. The plurality of stepping platforms are also less prone to deformation, offering greater durability and reliability.

### BRIEF DESCRIPTION OF THE DRAWINGS

FIG. 1 is a perspective view of an inverted Y-shaped foldable ladder in an unfolded state in a preferred embodiment of the present disclosure.

FIG. 2 is an enlarged view of an encircled part A in FIG. 1.

FIG. 3 is a perspective view of the inverted Y-shaped foldable ladder in the unfolded state in the preferred embodiment of the present disclosure.

FIG. 4 is an enlarged view of an encircled part B in FIG. 3.

FIG. 5 is a bottom view of the inverted Y-shaped foldable ladder in the unfolded state in the preferred embodiment of the present disclosure.

FIG. 6 is an enlarged view of an encircled part C in FIG. 5.

FIG. 7 is a rear view of the inverted Y-shaped foldable ladder in the unfolded state in the preferred embodiment of the present disclosure.

FIG. 8 is a rear view of the inverted Y-shaped foldable ladder in a folded state in the preferred embodiment of the present disclosure.

The reference numbers in the figures: 1—ladder frame; 11—front leg tube; 12—rear leg tube; 121—supporting rod; 2—stepping platform; 21—protective sleeve; 22—front section; 23—rear section; 24—rotatable buckle; 3—pulling rod; and 4—rear leg connecting rod.

### DETAILED DESCRIPTION OF THE EMBODIMENTS

The following will clearly and completely describe the technical solutions in the embodiments of the present disclosure.

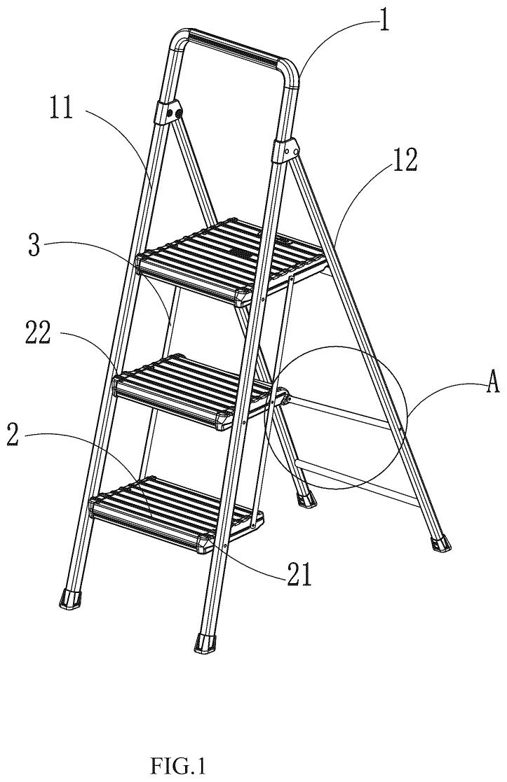

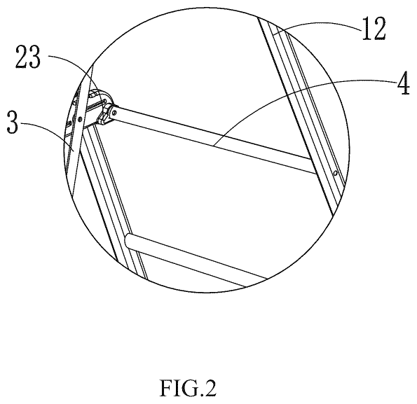

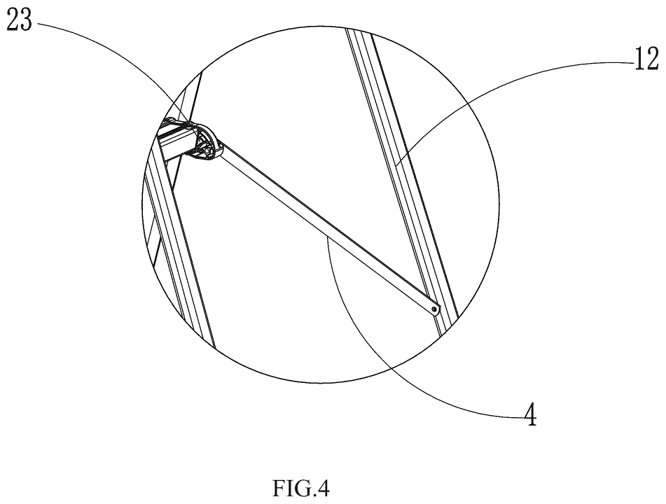

Referring to FIGS. 1-4, an inverted Y-shaped foldable ladder comprises two ladder frames 1 symmetrically disposed in a left-and-right direction, a plurality of stepping platforms 2 connected to the two ladder frames 1, one or more pulling rods 3 connected to one or more sides of each of the plurality of stepping platforms 2 to enable the plurality of stepping platforms 2 to be operatively coupled to one another, and one or more rear leg connecting rods 4. Each of the two ladder frames 1 comprises a front leg tube 11 and a rear leg tube 12, and one end of the front leg tube 11 and one end of the rear leg tube 12 are pivotally connected to each other to form an inverted Y-shaped unfolding and folding structure. The one or more rear leg connecting rods 4 are connected to one or two of the rear leg tubes 12 and one of the plurality of stepping platforms 2. An uppermost one of the plurality of stepping platforms 2, the one or more pulling rods 3, the one of the plurality of stepping platforms 2 connected to the one or more rear leg connecting rods 4, the one or more rear leg connecting rods 4, and the rear leg tubes 12 of the two ladder frames 1 are operatively coupled to one another, increasing convenience of unfolding and folding the inverted Y-shaped foldable ladder. In addition, since one end of each of the one or more rear leg connecting rods 4 is connected to the one of the plurality of stepping platforms 2 instead of the one or more pulling rods 3, the one or more rear leg connecting rods 4 are effectively prevented from applying force to the one or more pulling rods 3 to result in deformation of the one or more pulling rods 3 and increases durability of the inverted Y-shaped foldable ladder.

Each of the one or more sides of each of the plurality of stepping platforms 2 is disposed with a protective sleeve 21. On the one hand, the protective sleeve 21 can wrap sharper edges and corners of the plurality of stepping platforms 2. On the other hand, by adding the protective sleeve 21, at least one of a front section 22 or a rear section 23 of each of the one or more sides of each of the plurality of stepping platforms 2 extends outwardly (i.e., in a width direction of the plurality of stepping platforms 2), so that an overall shape of each of the plurality of stepping platforms 2 is changed. In other possible embodiments, the at least one of the front section 22 or the rear section 23 of each of the one or more sides of each of the plurality of stepping platforms 2 can extend directly without the protective sleeve 21.

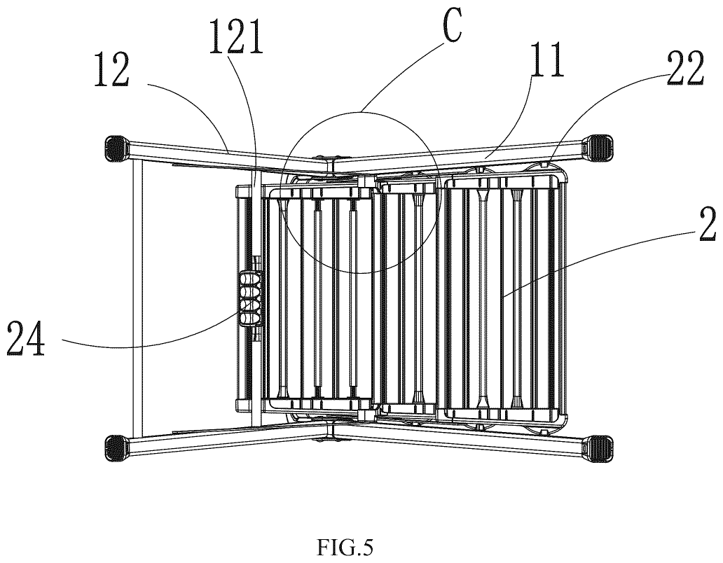

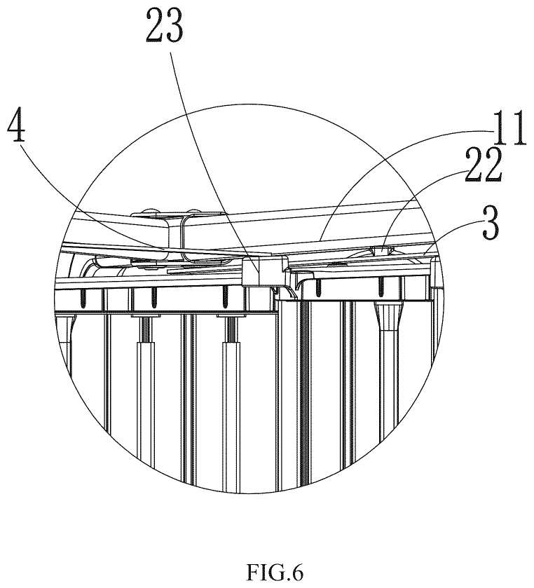

Specifically, the front section 22 of the one of the plurality of stepping platforms 2 pivotally connected to the one or more rear leg connecting rods 4 extends outwardly by a second length, the rear section 23 of the one of the plurality of stepping platforms 2 extends outwardly by a first length, and the second length is greater than the first length. By the above technical solution, the one of the plurality of stepping platforms 2 has three different widths at different positions, the front section 22 is pivotally connected to the front leg tube 11, the rear section 23 is pivotally connected to the one or more rear leg connecting rods 4, and the one or more pulling rods 3 are pivotally connected at a position between the front section 22 and the rear section 23. As shown in FIGS. 5 and 6, the front leg tube 11, the one or more rear leg connecting rods 4, and the one or more pulling rods 3 are misaligned with one another in the width direction of the plurality of stepping platforms 2 to minimize interfering with one another. Accordingly, the front sections 22 of the others of the plurality of stepping platforms 2 extend outwardly so that widths of the front sections 22 of the others of the plurality of stepping platforms 2 are the same as a width of the front section 22 of the one of the plurality of stepping platforms 2 pivotally connected to the one or more rear leg connecting rods 4. When the inverted Y-shaped foldable ladder is folded, the plurality of stepping platforms 2, the one or more pulling rods 3 and the one or more rear leg connecting rods 4 are all stored between the two ladder frames 1.

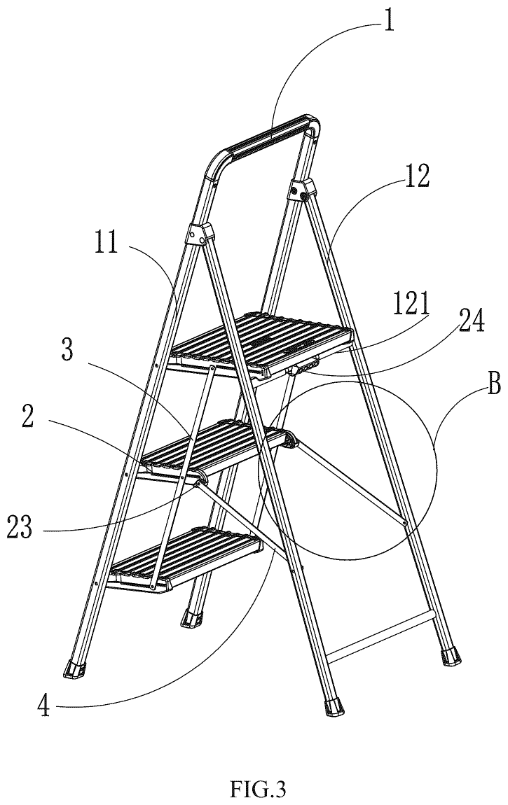

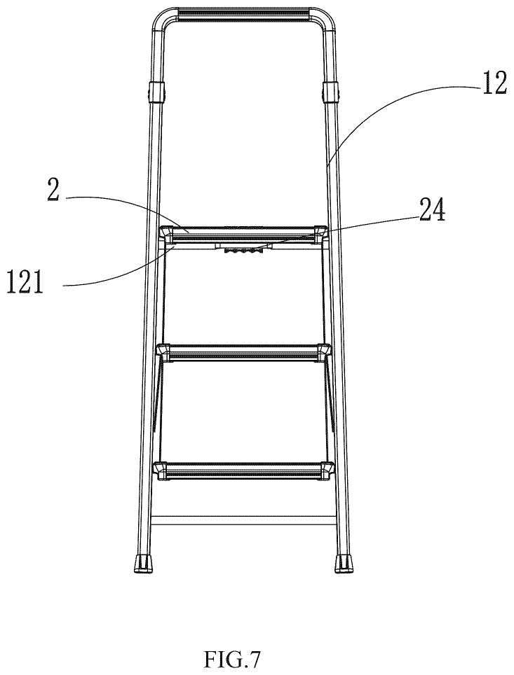

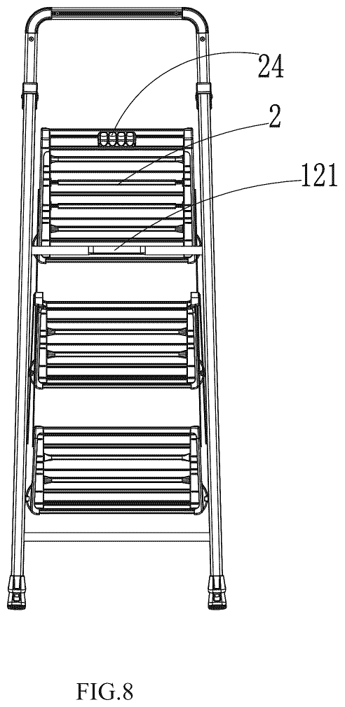

Referring to FIGS. 3, 7, and 8, a supporting rod 121 is connected to the rear leg tubes 12 of the two ladder frames 1. When the inverted Y-shaped foldable ladder is unfolded, a bottom of the uppermost one of the plurality of stepping platforms 2 abuts the supporting rod 121. The bottom of the uppermost one of the plurality of stepping platforms 2 is disposed with a rotatable buckle 24. When the bottom of the uppermost one of the plurality of stepping platforms 2 abuts the supporting rod 121, the rotatable buckle 24 is buckled to the supporting rod 121.

Returning to FIG. 5, a length of the uppermost one of the plurality of stepping platforms 2 is greater than or equal to a length of the others of the plurality of stepping platforms 2, and a top-down positive projection of an upper one of the plurality of stepping platforms 2 partially covers a lower one of the plurality of stepping platforms 2. Since adjacent two of the plurality of stepping platforms 2 partially overlap in a vertical direction, when a user inadvertently slips off of the upper one of the plurality of stepping platforms 2, the user is also able to step on the lower one of the plurality of stepping platforms 2, mitigating injury.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. An inverted Y-shaped foldable ladder having a pivotal linkage, comprising:
two ladder frames symmetrically arranged,
a plurality of stepping platforms,
one or more pulling rods, and
one or more rear leg connecting rods, wherein:
each of the two ladder frames comprises a front leg tube and a rear leg tube,
the front leg tube and the rear leg tube form an inverted Y-shaped unfolding and folding structure,
the plurality of stepping platforms are disposed between the front leg tubes of the two ladder frames,
the one or more pulling rods are connected to one or more sides of each of the plurality of stepping platforms, and
two ends of each of the one or more rear leg connecting rods are respectively pivotally connected to a corresponding one of the rear leg tubes of the two ladder frames and one of the plurality of stepping platforms.

2. The inverted Y-shaped foldable ladder according to claim 1, wherein:
a first of the two ends of each of the one or more rear leg connecting rods pivotally connected to the one of the plurality of stepping platforms is higher than a second of the two ends of each of the one or more rear leg connecting rods pivotally connected to the corresponding one of the rear leg tubes of the two ladder frames.

3. The inverted Y-shaped foldable ladder according to claim 1, wherein:
the one of the plurality of stepping platforms connected to the one or more rear leg connecting rods is successively connected to the front leg tubes of the two ladder frames, the one or more pulling rods, and the one or more rear leg connecting rods along a direction from the front leg tubes to the rear leg tubes.

4. The inverted Y-shaped foldable ladder according to claim 1, wherein:
a rear section of the one of the plurality of stepping platforms connected to the one or more rear leg connecting rods extends outwardly by a first length, and
the one or more rear leg connecting rods are pivotally connected to the rear section of the one of the plurality of stepping platforms.

5. The inverted Y-shaped foldable ladder according to claim 4, wherein:
a front section of each of the plurality of stepping platforms extends outwardly by a second length,
the front leg tubes of the two ladder frames are pivotally connected to the front section of each of the plurality of stepping platforms, and
the second length is greater than the first length.

6. The inverted Y-shaped foldable ladder according to claim 1, wherein:
a supporting rod is connected to the rear leg tubes of the two ladder frames, and
a bottom of an uppermost one of the plurality of stepping platforms is configured to abut the supporting rod.

7. The inverted Y-shaped foldable ladder according to claim 6, wherein:
the bottom of the uppermost one of the plurality of stepping platforms is disposed with a rotatable buckle, and
when the uppermost one of the plurality of stepping platforms is unfolded, the rotatable buckle is buckled to the supporting rod.

8. The inverted Y-shaped foldable ladder according to claim 1, wherein:
a length of an uppermost one of the plurality of stepping platforms is greater than or equal to a length of others of the plurality of stepping platforms.

9. The inverted Y-shaped foldable ladder according to claim 8, wherein:
a top-down positive projection of an upper one of the plurality of stepping platforms partially covers a lower one of the plurality of stepping platforms.

10. The inverted Y-shaped foldable ladder according to claim 1, wherein:
each of the one or more sides of each of the plurality of stepping platforms is disposed with a protective sleeve.

11. The inverted Y-shaped foldable ladder according to claim 1, wherein:
the one or more rear leg connecting rods are two rear leg connecting rods symmetrically arranged.
